(19) United States
(12) Patent Application Publication
(10) Pub. No.: US 2026/0366429 A1
(43) Pub. Date: Nov. 19, 2026

(54) ROTARY COMPRESSOR AND EXPANDER

(71) Applicant: COOOL.ENERGY LTD, Kibbutz Erez (IL)

(72) Inventor: Michael ZETTNER, Omer (IL)

(21) Appl. No.: 19/132,494

(22) PCT Filed: Dec. 28, 2023
(86) PCT No.: PCT/IL2023/051331

§ 371 Date: May 23, 2025

(30) Foreign Application Priority Data
Dec. 29, 2022 (IL) 299605

(51) Int. Cl. F01C 1/28; F01C 19/00; F01C 21/00; F01C 21/08

(52) U.S. Cl. CPC F01C 1/28; F01C 19/00; F01C 21/08; F01C 2021/1675

(57) ABSTRACT

An apparatus that may be used as a compressor or expander, has a main rotor, a stator, and a plurality of auxiliary rotors. Blades extending from the rotor into a confined annular space to define with portions of the auxiliary rotors, chambers that shrink when a blade advanced towards such portion or expands when the blade recedes from such portion, giving rise to fluid compression or extension. The auxiliary rotors comprise each one or more radially extending annular flow control element having an annular portion intersecting at least one of the flow paths into or out of the confined annular space, the intersecting annular portion having one or more arcuated openings, whereby the annular portions control the flow of fluid through such flow paths.

### TECHNOLOGICAL FIELD

### Background Art

References considered to be relevant as background to the presently disclosed subject matter are listed below:
U.S. Pat. No. 4,890,990
U.S. Pat. No. 9,638,035

Acknowledgement of the above references herein is not to be inferred as meaning that these are in any way relevant to the patentability of the presently disclosed subject matter.

### Background

U.S. Pat. No. 4,890,990 discloses a rotary engine in which the expansion pressure of a working gas is converted into a mechanical rotary movement. A rotor with three spaced projections, rotates in closed space and causes to transmit the expansion pressure of the gas to an inner element, and three expansion chambers between the projections. Four reaction members, which are each movable into the expansion chambers in turn and transmit the gas expansion pressure to the outer element, are mounted at the circumferential surface of the outer element. The two circumferential surfaces have the form of complementary annular surfaces, wherein in cross-section the inner surface has the shape of a concave, parabola-like curve and the outer surface the shape of a convex, parabola-like curve. The surfaces extend parallel to each other with close sliding fit up to their outer edges.

A rotary engine comprised of at least one and usually a plurality of independent partial engines is disclosed in U.S. Pat. No. 9,638,035. Two different and separate closed cycle processes can operate within the engine, i.e. the same expansion chamber or expansion chambers, at the same time. The primary process performs the main function of converting heat to kinetic energy. The process utilizes the expansion of gases and also the contraction of the condensation of gases after their expansion.

### GENERAL DESCRIPTION

Provided by this disclosure is an apparatus with a main rotor, that rotates about a central axis, and that can compress a fluid. Uniquely, by some embodiments of this disclosure, all motions in the apparatus of this disclosure are rotational. In some embodiments, the apparatus has an axial symmetric design (namely is fully symmetrical about any line passing through and normal to the central axis). Through axial symmetry the apparatus may be fully balanced during its operation, and moments that may otherwise form in the apparatus through rotation of its main rotor are substantially cancelled through counter rotation of other rotors, symmetrically disposed around the main rotor. These other rotors are referred to herein as “auxiliary rotors”.

The axial symmetric design, in embodiments in which it exists, applies primarily to the functional parts of the apparatus. The stator, for example, may be part of or be coupled to a frame that is engineered to have a non-axial symmetric design.

The apparatus by some embodiments of this disclosure can be configured to operate as a compressor; that may yield a high energy efficiency of converting mechanical energy into pressurized fluid. The apparatus of this disclosure may also be configured to operate as an expander; that may yield a high energy efficiency of converting pressure into mechanical energy. By yet other embodiments of this disclosure the apparatus can be configured to operate both as a compressor and as an expander, at different operational modes; that may yield a high energy efficiency of converting mechanical energy into pressurized fluid in its compressor operational mode and high energy efficiency of converting pressure into mechanical energy, in its expander operational mode.

In its compressor configuration of the apparatus, the main rotor may be coupled to and operated by an electric motor or any other suitable motor. It the expander configuration of the apparatus the main rotor may be coupled to an electric generator or any other energy conversion device. The coupling to a motor, e.g. the electric motor or electric generator, may be direct or through a gear system.

The rotational direction in which the rotor rotates for the purpose of compressing a fluid, may be referred to herein as “first direction of rotation” or “first rotational direction”. The rotational direction in which the rotor rotates for the purpose of expansion of a compressed fluid, may be referred to herein as a “second direction of rotation” or “second rotational direction”.

The apparatus of this disclosure comprises a main rotor, a stator, a plurality of auxiliary rotors disposed in the stator, a plurality of chamber blades extending from the main rotor into an annular, a confined annular fluid space and a valving arrangement for the control of fluid outflow from the chamber and fluid inflow into the chamber, flowing through respective first and second fluid flow paths. As will be appreciated from the description below, the confined annular fluid space is not a continuous chamber but is interrupted by the abutting portions (see below) of the auxiliary rotors (see below), and hence consists of several individual segments, each one extending between two consecutive abutting portions. Thus, although the term “space” is used herein for the annular space confined between the stator and the rotor, it should be understood to consist of a plurality of separate segments arranged about the rotor's axis of rotation; and where the apparatus has an axially symmetric design, the segments are all of the same design and are axially symmetrically disposed about the man axis.

The main rotor is rotatable about a central axis and has a peripheral rotor surface. The stator has an internal annular stator surface, that is defined by a plurality of segments, that are spaced apart from said peripheral surface to define an annular confined space therebetween. This chamber is substantiality sealed from the external environment.

The term “substantially” in connection with a seal or a sealing engagement is used herein to denote that while the seal or sealing engagement may not be absolute, and leakage of fluid through the seal is minimal, having minimal, of any, functional significance.

The plurality of identical auxiliary rotors are disposed in, and, where the apparatus has an axial symmetric design, are axially symmetrically disposed in said stator around the main rotor. Each of these elements is geared to the main rotor and rotatable therewith in a second rotational direction, opposite to that of the main rotor about an auxiliary axis that is parallel to the central axis. Each of the auxiliary rotors has a central, generally cylindrical, abutting portion with an engaging surface that abuts into the annular chamber between consecutive segments of the internal annular stator surface and is configured to roll with sealing engagement over the external peripheral surface of the rotor.

The term “generally cylindrical” should not be understood in a geometrical sense, but rather as meaning a form which looks overall cylindrical, albeit may have some deviation from a cylindrical geometry. For example, the generally cylindrical portion may have rounded lateral edges that match the curvature of the lateral edges of the chamber for a sealing engagement therewith.

The plurality of chamber blades are members that are disposed on said peripheral surface of the rotor and extend therefrom into said annular chamber, each of which substantially sealingly engage said internal surface of the stator. Where the apparatus has an axial symmetric design, the blades are also axially symmetrically disposed on the main rotor. The chamber blades are configured to span the entire breadth of the annular chamber to engage the side face of said chamber in a substantially sealing manner, whereupon each blade separates between two separate transient compartments oppositely extending from opposite faces of the blades, and that rotate with the rotating blades serving different functions at different stages of the blades'rotation. The transient compartments are defined between the blades and the auxiliary rotors'abutting portion, and, as noted also below, the compartment defined between an abutting portion and an approaching blade operating to compress the working fluid (WF) other than right before reaching said portion and being received within a groove), while there is WF intake into the opposite compartment, namely the one formed between an abutting portion and a blade receding therefrom.

One or more, typically two oppositely disposed, engaging grooves are defined in the engaging surface, extending in a generally axial direction between the two lateral faces of the cylindrical portion. Each of the grooves are configured to sealingly receive one of the chamber blades during the oppositely directed rotations of the auxiliary rotors and said main rotor. The auxiliary rotors are geared to the main rotor such that during this rotation a duty blade of the plurality of chamber blades is received within a duty groove of the one or more engaging grooves.

The terms “duty blade” and “duty groove”, used herein, refer to a chamber blade and a groove, respectively, that are about to come into engagement with one another, in which engagement the duty blade is received within the duty groove. To permit such engagement, the rotation of the auxiliary rotors, that are geared to the main rotor, must be synchronized with that of the rotor.

In an axially symmetrical design of the apparatus, each chamber blade has an opposite chamber blade that is in the same relative position vis-à-vis an auxiliary rotor; similarly each auxiliary rotor has an opposite auxiliary rotor that is in the same rotational phase. Thus, for example, when one duty blade engages with a duty groove of one auxiliary rotor, the opposite duty blade engages the duty groove of the opposite auxiliary rotor.

Defined in the stator are a plurality of first and second fluid flow paths that extend from respective first and second ports in the internal annular stator surface. Associated with each auxiliary rotor are a pair of flow paths consisting of one first and one second flow path and their corresponding first and second ports. The first port is disposed on one side of the auxiliary rotor that faces the first direction of rotation, namely that side from which the rotating chamber blades approach the auxiliary rotor when rotating in the first direction, and the second port is disposed on the other side of the auxiliary rotor.

The auxiliary rotors comprise each one or more radially extending annular flow control element having an annular portion that intersects at least one of the flow paths. The intersecting annular portion has one or more arcuated openings. In a rotational phase in which one the openings is in register with the flow path, the flow path is open; and is closed in other rotational phases. Typically, although not exclusively, said annular portion is common to and intersect with both the first and the second flow paths. Thus, in such a case, the same openings will serve to open the first fluid flow path in certain rotational phases and the second fluid flow path in others.

By an embodiment of this disclosure each auxiliary rotor comprises two flow control elements, each one operable in a different operational modes or configurations of the apparatus: typically, one operable when the apparatus is configured or is operable to work in as a compressor, and the other operable when the apparatus is configured or is operable to work as an expander. The two flow-control elements are, typically, equally spaced from and at opposite sides of the abutting portion. By an embodiment of this disclosure, each of the flow control element comprises two arcuated openings axially symmetrical about the auxiliary axis.

By an embodiment of this disclosure, the rotor is part of a rotating block that comprises a main gear wheel and a gate gear. The main gear is geared to a cogged portion of the auxiliary rotor, typically an end portion thereof, to thereby rotate the auxiliary rotors. The gate gear has gating component that are dimensioned for coupling with counterpart gating components on a gating portion of the auxiliary rotors. The gating components may be gating blades, e.g. on an end portion of the auxiliary rotors, and said counterpart gating components are matching gating grooves, e.g. on the gaiting gear. One of the functions of the gating component is to ensure proper alignment of the auxiliary rotors during assembly of the apparatus. During assembly the, the auxiliary rotors are positioned such that said gating component is aligned with said counterpart component this ensuring proper alignment of the auxiliary rotors. According to an embodiment, the gating components on the gating gear are in angular alignment with the chamber blades and said counterpart gating component is in an angular alignment with one of the engaging grooves on the abutting portion of the auxiliary rotor.

By an embodiment the stator is assembled from a plurality of sectorial stator segments, each defining a segment of the internal annular stator surface. The number of stator segments is equal to the number of auxiliary rotors. Where the apparatus has an axially symmetric design, the sectorial stator segments are identical and are axially symmetrically disposed about the central axis. By an embodiment each auxiliary rotor is received in a dedicated space that is defined between a pair of neighboring sectorial segments. Generally, the auxiliary rotors are configured to rotate at tight fitness within a dedicated space within the stator.

By an embodiment, each of said engaging grooves has a generally rectangular cross-sectional shape with rounded external lips; and each of said chamber blades has a generally concave hourglass cross-sectional shape, with concave side walls extending between the bases of the blade and its peripheral face. The chamber blades and the engaging grooves are mutually configured by their shape and dimensions, such that during entry to and exit of a blade from an engaging groove, a side wall of the chamber blade and one of the engaging groove's lips or a peripheral face of the chamber blade and an internal face of the engaging groove are substantially sealingly engaged. In other words, during the entry phase of a duty blade into a duty engagement groove as the two rotate in opposite direction, the concave hourglass-shaped side wall slide over the lips over and maintain a sealing engagement with the duty groove's lips until its peripheral face engages the inner face of the duty groove and the opposite occurs upon exits. This ensures substantial sealing engagement of the chamber blades throughout all phases of their rotation-both during their movement through the annular chamber and during its engagement with said engaging groove.

By an embodiment of this disclosure, the apparatus comprises a first number of blades and a second number, smaller than the first number, of auxiliary rotors; both numbers being, typically, even numbers. For example, the apparatus may comprise 7n of said blades and 6n of said auxiliary rotors, with n being an integer (n=1, 2, 3, 4, etc.), typically an even integer (n=2, 4, etc.). For example, the apparatus may comprise 14 blades and 12 auxiliary rotors (namely, n=2).

By an embodiment of this disclosure, each of the auxiliary rotors comprises two engaging grooves, that are opposite one another (namely 180 degrees from one another) in an axial symmetric manner about the auxiliary axis. This means that the auxiliary rotor completes half a revolution between engagement of one duty blade in one duty groove and engagement of a subsequent one in the other duty groove of an auxiliary rotor.

The term “duty cycle” may be used herein to denote an operational cycle between engagement of one duty blade in one duty groove and engagement of a subsequent one in the other duty groove of an auxiliary rotor.

There may be two axially symmetrically disposed arcuated openings, one operating in one duty cycle and the other in the other duty cycle; namely, during full rotation the respective flow path will open twice and close twice. In such an arrangement, where, for example there are 14 chamber blades and 12 auxiliary rotors, the auxiliary rotor completes 3.5 revolutions when the main rotor completes one; namely, the revolution rate of the auxiliary rotors is 3.5 times that of the mani rotor.

By an embodiment of this disclosure, each of the first and second paths comprise a first section that is formed by a throughgoing bore extending a along a bore axis substantially parallel to the auxiliary axis (and, hence, also to the main axis) and comprises a second section with one or more ducts that extend from the first section to the annular chamber, e.g. extending along a duct axis that is normal to said bore axis. The ports (including the first and/or the second ports) that are defined by the one or more ducts may be formed at an internal annular stator surface adjacent said cylindrical portion. The throughgoing bore, that defines the first flow path section may extend between a proximal opening at one side of the stator and the opposite side, with the first section being defined between the proximal opening and a sealing barrier within the bore distal to said second section.

By an embodiment of this disclosure, the first fluid flow paths open to a compressed fluid drain at one side of the stator and said second fluid flow paths open to a fluid source at the other side of the stator.

This disclosure has several aspects: a “compressor aspect” in which the apparatus operates to compress a fluid or is configured for that purpose; an “expander aspect” in which the apparatus utilizes compressed fluid to generate kinetic energy; as well as a “combined aspect” in which the apparatus can serve both functions. Other than the apparatus, each aspect also encompasses a, respective, compressor system, expander system and a combined system. An apparatus embodying the features of this disclosure intended for use as a compressor may be engineered in a different manner than one intended for use as an expander. However, it is also possible for the compressor and expander to have the same overall engineering design. Also, as already noted, by embodiments of this disclosure the same apparatus may serve for use as both a compressor and an expander.

It should be noted that embodiments of different elements described for one of the aspects may also constitute embodiments of the other.

### Compressor Aspect

The apparatus of some embodiments of this disclosure that can operate in a compression operational mode in which rotational energy is converted into pressurized fluid.

In the compression operational mode of the apparatus, said annular confined space serves for compression of a working fluid (“WF”) and may be referred to, in this context, also as “compression chamber”. Depending on the operational temperature and the nature of the WF, the WF, which may enter the compression chamber through a second flow path while in a gas phase, may remain as gas, albeit compressed, after compression in the chamber or may, by some embodiments, partially or fully condense into liquid; for example be a gas or a mixture of a gas with dispersed liquid droplets of the same or different substance as the gas.

The main rotor is rotatable in a first, compression direction of rotation about a central axis and the chamber blades define, with abutting members towards which they approach, transient compression chambers

The one or more arcuated openings define a valving arrangement for selectively synchronized opening and closing the first and second flow paths to yield (i) intake of fluid through a second port into an intake compartment temporarily defined between an abutting portion of an auxiliary rotor and a blade that rotates away from the abutting portion, (ii) compression of fluid in a compression compartment temporarily defined between an abutting portion of an auxiliary rotor and a blade that rotates towards the abutting portion, and (iii) discharge of compressed fluid from said compression compartment through a first port when the blade of said chamber is proximal to the abutting portion. By some embodiments the valving arrangements is such so as to open the first flow path, when an approaching duty blade is in proximity to the abutting portion and close the first flow path after the duty blade disengages a duty groove of the auxiliary rotor; and open the second flow path when a duty blade disengages a duty groove and close the second flow path when the next duty blade is fully received in a duty groove.

By an embodiment of this disclosure, the first fluid flow paths open to a fluid drain at one side of the stator and said second fluid flow paths open to a fluid source at the other side of the stator.

Also provided by this aspect is a compressor system. It comprises an apparatus according to this disclosure operating in a fluid compression operational mode and a motor, for example an electrical motor, rotationally coupled to the main rotor for rotating the rotor in said first rotational direction.

### Expander Aspect

The apparatus of some embodiments of this disclosure that can operate in an expansion operational mode, in which pressure can be converted into a kinetic energy, comprises parts as generally defined above. The differences resides, among others, in the function of the flow paths, including the valving arrangement that controls the flow in them, and in the rotational direction. The description below will focus primarily on these differences.

In the expansion operational mode of the apparatus, said annular space serves for expansion of a working fluid (WF) and may be referred to, in this context, also as “expansion chamber”. The WF may be the same or different than that utilized in the compression aspect. Depending on the operational temperature and the nature of the compressed WF, which can enter the compression chamber through a first flow path, may be a pressurized WF in a gaseous phase or may condensed or partially condensed WF, namely a liquid or a mixed phase WF, which is then expanded to a gaseous form while performing work and causing rotation of the rotor.

The main rotor is rotatable in a second, expansion direction of rotation about a central axis, The auxiliary rotors are accordingly rotated in an opposite direction of rotation, namely in the first rotational direction.

The first and second fluid flow paths and their respective first and second ports, have a different function than in the compression aspect, with the former serving for intake of pressurized fluid into the expansion chamber, where it exerts a force on the blades leading to rotation of the rotors, and the latter for exhausting the expanded fluid.

The valving arrangement, defined by the one or more arcuated openings, functions to enable selective synchronized opening and closing of the first and second flow paths, to yield (i) intake of pressurized fluid through a first port into a pressurized fluid compartment temporarily defined between an abutting portion of an auxiliary rotor and a blade that rotates away from the abutting portion, (ii) expansion of fluid in an expansion compartment temporarily defined between an abutting portion of an auxiliary rotor and a blade that rotates away from the abutting portion, and (iii) discharge of the expanded fluid from said expansion compartment out through a second port when the blade of said compartment is proximal to the abutting portion.

By an embodiment of this disclosure, the first fluid flow paths open to a source of pressurized fluid at one side of the stator and said second fluid flow paths open to a fluid drain at the other side of the stator.

Also provided by this aspect is an expander system. It comprises an apparatus according to this disclosure operating in a fluid expansion operational mode and an energy generator, e.g. an electric generator, rotationally coupled to the main rotor for generating energy from the rotation.

### Combined Aspect

The apparatus of some embodiments of this disclosure is operable both in a fluid compression and in fluid expansion operational modes; namely both for converting energy, e.g. electric energy, into a pressurized fluid and for utilizing pressurized fluid for the generation of kinetic energy that may be converted, for example, into electric energy. The apparatus comprises parts as generally defined above. The main rotor is, thus, rotatable in a first compression direction and in an opposite second, expansion direction of rotation about the central axis. The flow path and the valving arrangement are configured to operate in both operational modes. The description below will mainly outline the unique elements of this apparatus vis-à-vis those described above.

The plurality of first and second fluid flow paths extend from respective first and second ports in the internal annular stator surface. Each pair of a first flow path and second flow paths and their respective first and second ports are associated with one auxiliary rotor, with the first port being disposed on one side of the auxiliary rotor that faces the first rotational direction and the second port on the other side of the auxiliary rotor.

The valving arrangement, defined by the one or more arcuated openings, is configured for selectively synchronized opening and closing the first and second flow paths to yield: (1) in said compression rotation (i) intake of fluid through a second port into an intake compartment temporarily defined between an abutting portion of an auxiliary rotor and a blade that rotates away from the abutting portion, (ii) compression of fluid in a compression compartment temporarily defined between an abutting portion of an auxiliary rotor and a blade that rotates towards the abutting portion, and (iii) discharge of compressed fluid from said compression compartment out through a first port when the blade of said compartment is proximal to the abutting portion; and (2) in said expansion rotation (i) intake of pressurized fluid through a first port into a pressurized fluid compartment temporarily defined between an abutting portion of an auxiliary rotor and a blade that rotates away from the abutting portion, (ii) expansion of fluid in an expansion compartment temporarily defined between an abutting portion of an auxiliary rotor and a blade that rotates away from the abutting portion, and (iii) discharge of the expanded fluid from said expansion compartment out through a second port when the blade of said compartment is proximal to the abutting portion.

Also provided by this aspect is a system for use in compressing a fluid and in utilizing a compressed fluid for generation of energy. It comprises an apparatus of this disclosure operable both in compression and expansion operational mode and (i) a motor rotationally couplable to the main rotor in a compression operational mode, for rotating the rotor in said first rotational direction, and (ii) an energy generator rotationally couplable to the main rotor in an expansion operational mode for rotating the rotor in said second rotational direction. The coupling of the main rotor to either the motor or the energy generator may be through a gear system configured from coupling the motor when the apparatus is intended to operate in the compression operational mode and to the generator when the apparatus is intended to operate in the expansion operational mode.

Also provide by other aspects are individual elements of the apparatus. These include (i) the auxiliary rotors, (ii) a rotating block that comprises the rotor and (iii) individual stator segments configured for assembly of the stator, all configured for use in an apparatus of this disclosure.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying schematic drawings, in which:

FIG. 1 is an isometric view of an apparatus according to an embodiment of this disclosure with a cover removed to show the main rotor and its coupling to the auxiliary rotors.

FIG. 2A is a longitudinal cross-section, normal to the axis, and partial isometric view of the apparatus of FIG. 1.

FIG. 2B is an enlarged view of the top part of the cross-section of FIG. 2A.

FIGS. 3A-3C are close-up, side view of a portion of the apparatus seen in FIG. 2B, illustrating the opening and blocking of the fluid flow paths at various rotation positions of the chamber blades and rotational phases of the auxiliary rotors.

FIGS. 4A-4C illustrate various stages of engagement of a chamber blade and an engaging groove.

FIGS. 5A-5F show various isometric views of an isolated rotor segment and an auxiliary rotor, with a cut-out portion at the bottom right to permit viewing of fluid flow path formed in the rotor segment and the operation of the flow control element, in several rotational phases, wherein: FIG. 5A shows the auxiliary rotor in a first rotational state in which the flow path is blocked: FIG. 5B is a rotational state in which the arcuated opening is in register with the flow path, which is accordingly open; FIGS. 5C-5D are close-up views and FIGS. 5E-5F are side views in states corresponding to FIGS. 5A-5B, respectively.

FIG. 6 is a front isometric view of the apparatus of FIG. 1 with a rotor segment and one auxiliary rotor being removed.

FIG. 7 is and upper isometric view with 4 auxiliary rotors and 4 rotor segments being removed.

FIG. 8 is an isometric view of the main rotor block of the apparatus.

FIGS. 9A-9B illustrate the manner in which the auxiliary rotors are properly positioned with the aid of the gait gear, wherein FIG. 9A is a general isometric view showing the rotor block with one auxiliary rotor and one stator segment and FIG. 9B is a close-up isometric view from the side.

### DETAILED DESCRIPTION OF EMBODIMENTS

In the following description some illustrative and non-limiting embodiments will be described with reference to the annexed drawings.

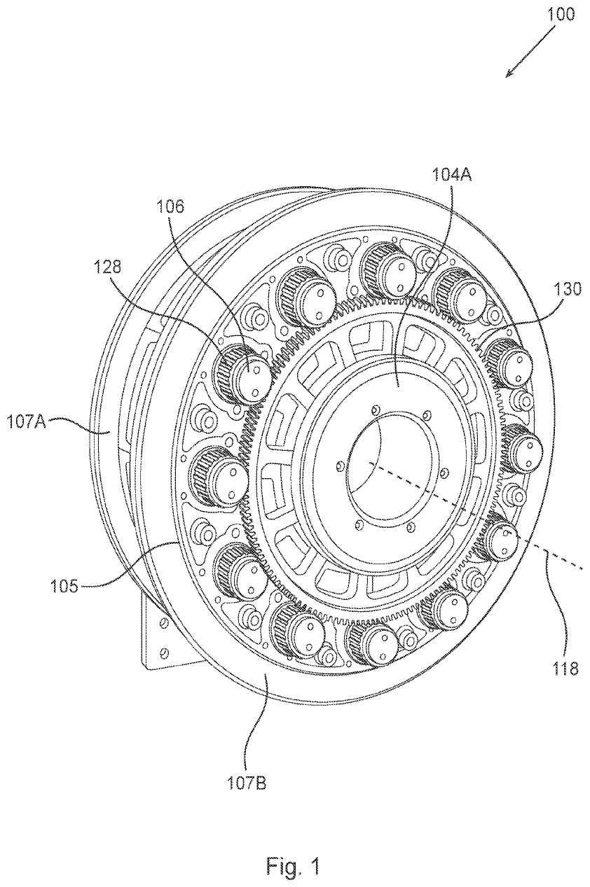

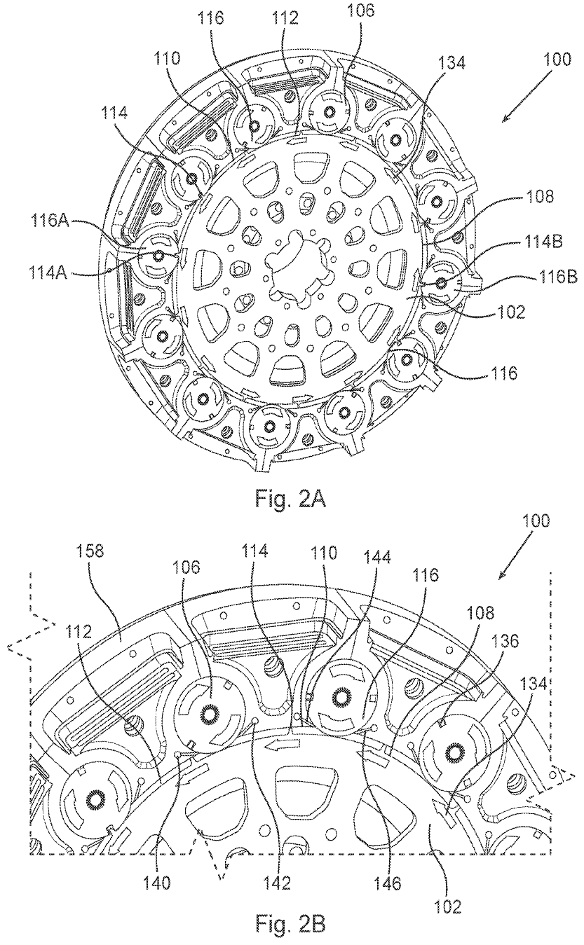

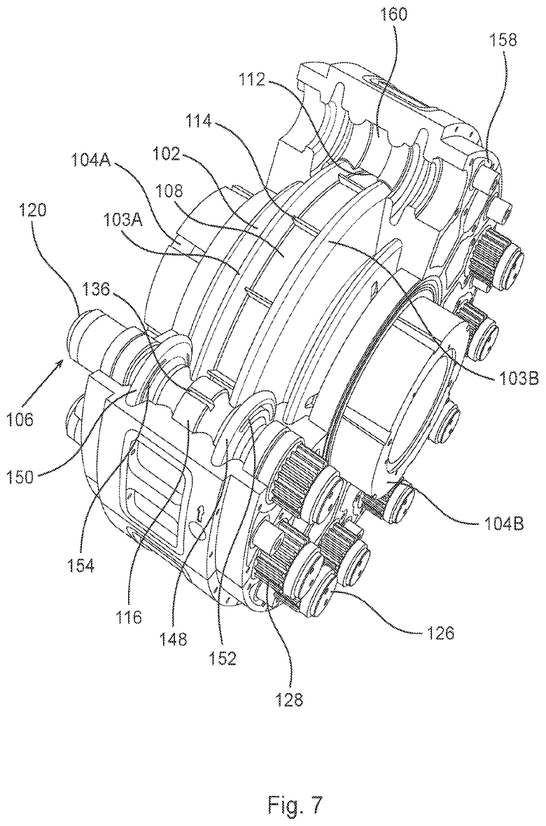

Referring first to FIGS. 1-2B, an apparatus 100 is shown that has a main rotor 102, of which the external elements 104A is seen in FIG. 1 and the other external element 104B seen in FIG. 7. The rotor 102 can best be seen in FIG. 2A, with some of its elements, seen enlarged in FIG. 2B. The apparatus 100 has a stator 105 with twelve (12) auxiliary rotors 106 disposed therein. The stator 105 is composed on individual stator segments, to be discussed below, that are held together by tensioning rings 107A, 107B.

Defined between a peripheral rotor surface 108 and an internal annular stator surface 110 is a confined annular fluid space 112. As can be seen in particular in FIGS. 7-9 the rotor 102 has radially extending side rims 103A,103B that define side walls of the confined annular space 112. The internal rotor surface 108 is, in fact, constituted by twelve individual surface segments, each extending between consecutive abutting portions 116 of the auxiliary rotors 106, the gap between consecutive segments forming an opening that permits the abutting portions 116 to abut therethrough into the confined annular space 112. Fourteen (14) chamber blades 114 project from the peripheral rotor face 108 into the confined annular fluid space 112, each of which substantially sealingly engages surface 110. The confined annular fluid space is not a continuous chamber but is interrupted by abutting portions 116 of the auxiliary rotors 106, and hence consists of several individual segments, each one extending between two consecutive abutting portions 116.

The main rotor is rotatable about a central axis, represented by a dashed line 118 in FIGS. 1A-1B.

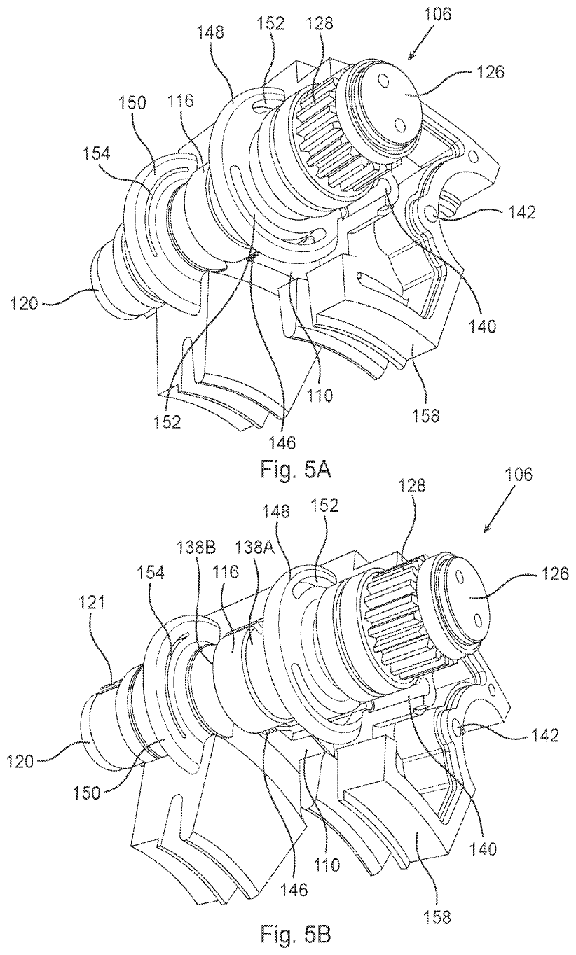

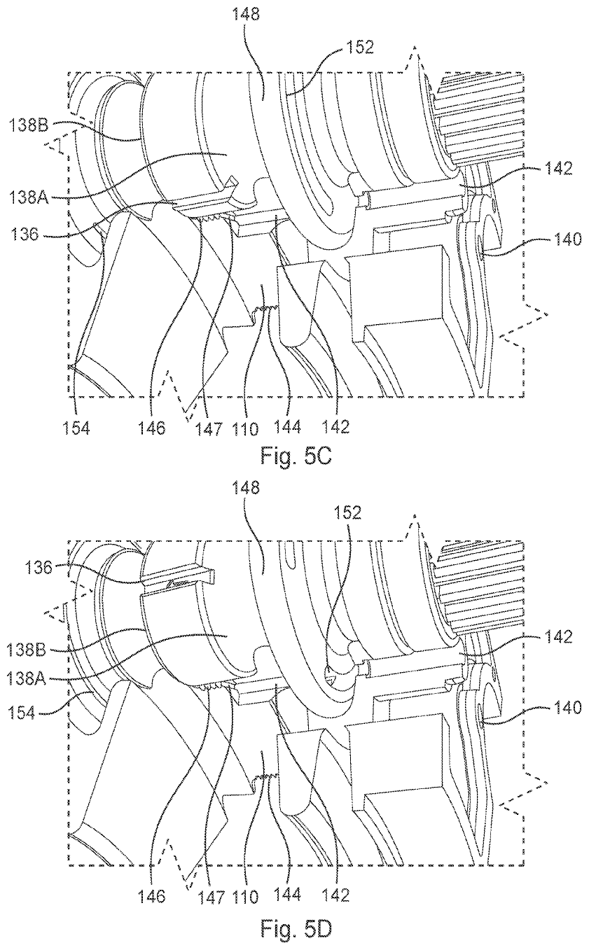

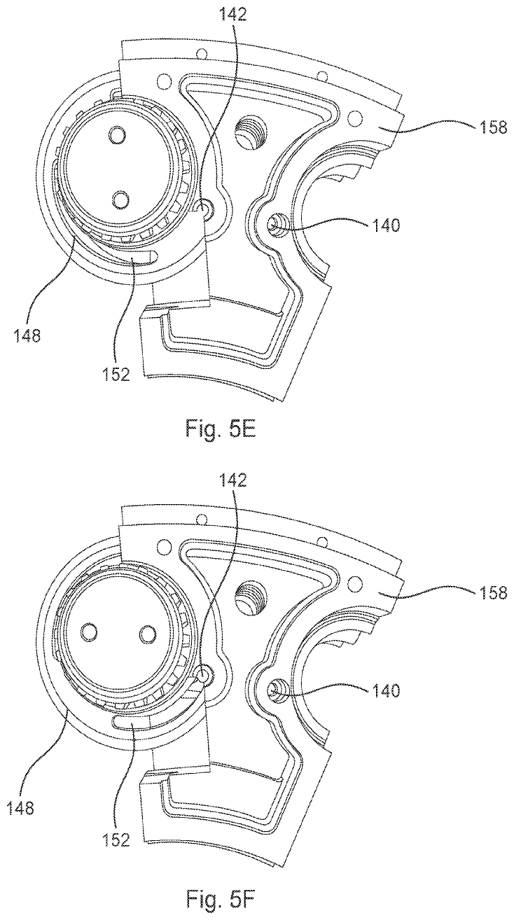

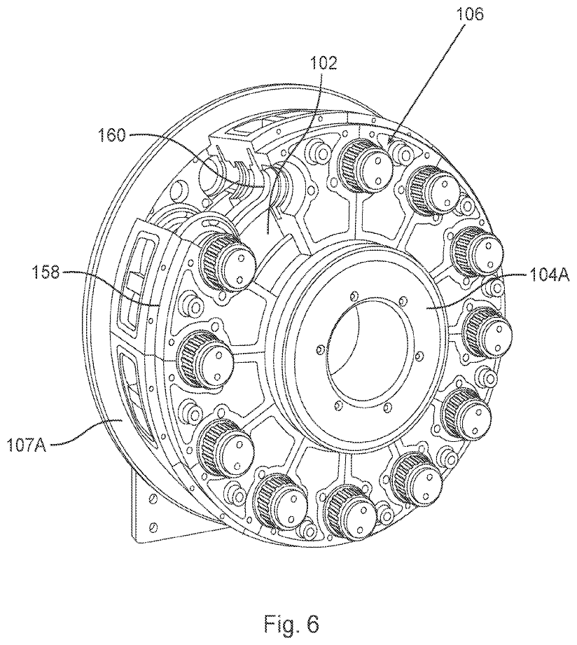

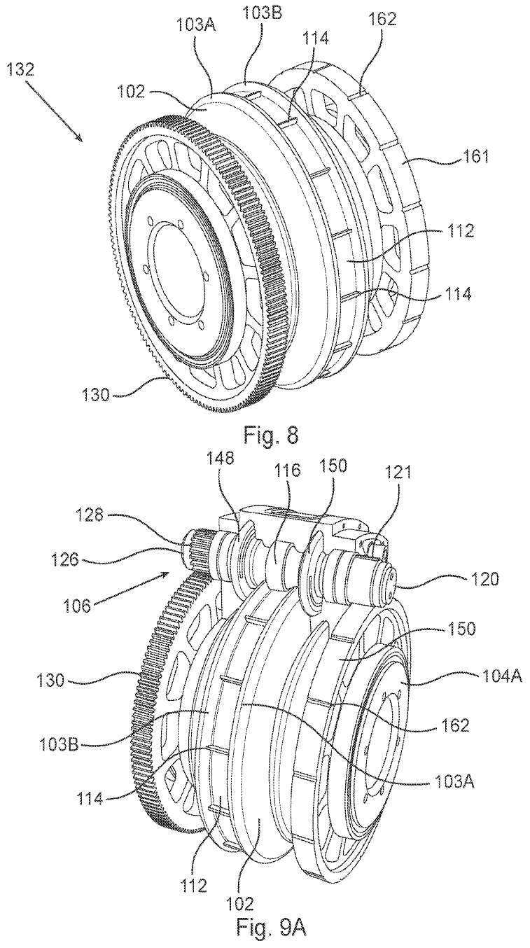

The plurality of auxiliary rotors 106 are axially symmetrically disposed in said stator around in the main rotor and are each axially rotatable about an auxiliary axis that is parallel to the main axis. As can be seen in FIG. 1, one cylindrical end portion 126 of the auxiliary rotor 106 has a cogged face 128, geared to the main gear 130, that is part of the rotor block 132 (seen in FIG. 8), which will be explained further below. Through this gearing the rotation of the main rotor 102 and the auxiliary rotors 106, is synchronized. The overall shape of the auxiliary rotors 106 can best be seen in FIGS. 5A-5B, 7 and 9A.

As noted above, each of the auxiliary rotors 106 has a central, generally cylindrical, abutting portion 116 with an engaging surface that abuts into the annular chamber between consecutive segments of the internal annular stator surface 110 and is configured to roll with sealing engagement over the external peripheral surface 112 of the rotor 102.

The chamber blades 114 are configured to span the entire breadth of the annular chamber to engage the opposite face of said chamber in a substantially sealing manner. Thus, each blade separates between two separate transient compartments oppositely extending from the two opposing faces of the blades, and that rotate with the rotating blades serving different functions at different stages of the blades'rotation.

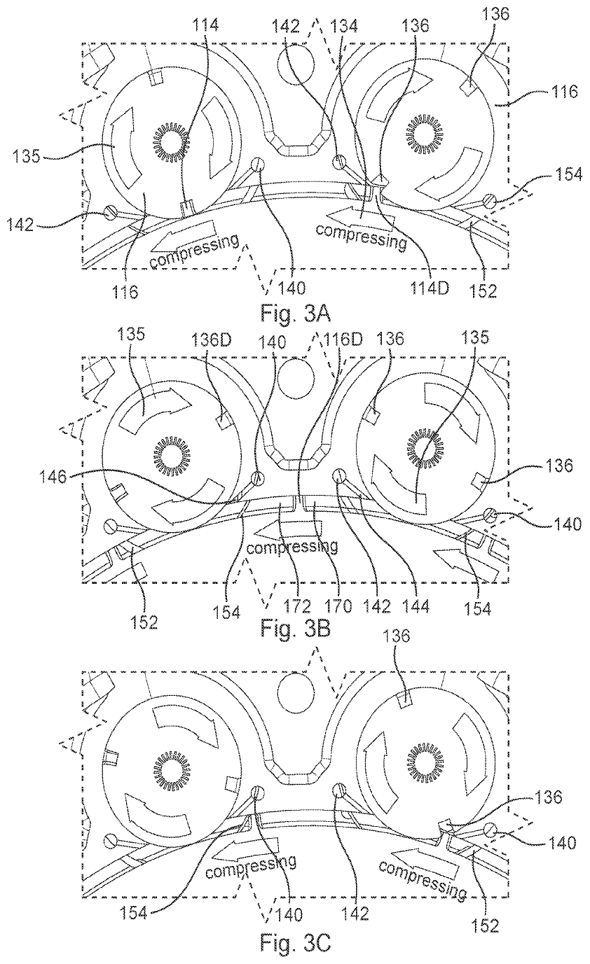

The embodiments described below are focused primarily on the use of the apparatus 100 as a compressor. However, it is readily understood that similar operational principles apply for an expander operational mode, in which the main rotor rotates in an opposite rotational direction. In its operation as a compressor, there are transient compartments that are defined between the blades 114 and the auxiliary rotors'abutting portion 116, the compartment 170 that is defined between an abutting portion 116 and an approaching chamber blade 114—see FIG. 3B, where the rotational direction is counter clockwise, marked by arrows 134, operating to compress the WF (other than right before reaching said portion and being received within a groove), while there is WF intake into the opposite compartment 172, formed between an abutting portion and a blade receding therefrom.

As can be seen in FIGS. 2A-3C, two oppositely disposed engaging grooves 136 are defined in the abutting portion 116, extending in a generally axial direction, as can best be seen in FIGS. 5C-D and 7, between the two lateral faces 138A,138B of the abutting portion 116. Each of the grooves 136 is configured to sealingly receive one of the chamber blades 114 during the oppositely directed rotations of the auxiliary rotors 106 and the main rotor 102. The auxiliary rotors are geared to the main rotor such that during this rotation a duty blade of the plurality of chamber blades 116 is received within a duty groove of the one or more engaging grooves.

The terms “duty blade” and “duty groove”, used herein, as also noted above, refers to a chamber blade and a groove, respectively, that are about to come into engagement with one another, in which engagement the duty blade is received within the duty groove. In FIG. 3B, for example, blade 114D and groove 136D are, respectively, a duty blade and a duty groove 136D, as the main rotor rotates in the direction of arrows 134 (counterclockwise in the view) while the auxiliary rotors rotate in an opposite rotational direction, as represented by arrows 135 (clockwise in this view).

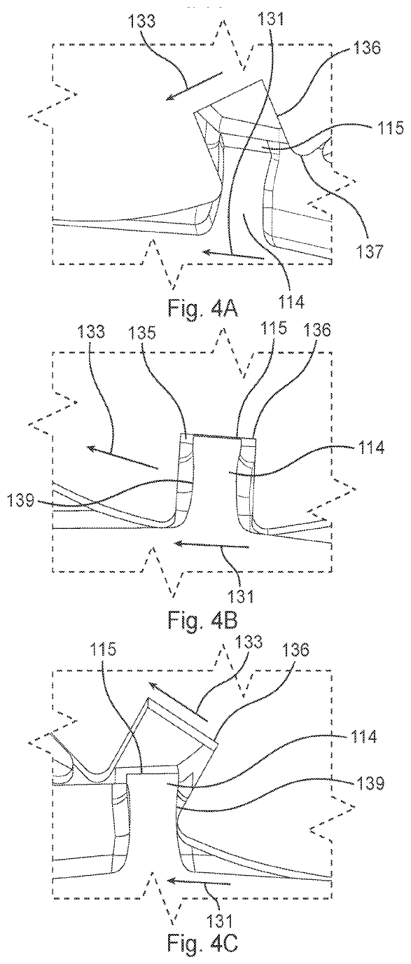

As can be seen in FIGS. 4A-4C, each of the engaging grooves 136 has a generally rectangular cross-sectional shape with rounded external lips 137; and each of the chamber blades 114 has a generally concave hourglass cross-sectional shape, with concave side walls extending between the bases of the blade and its peripheral face 115. The main rotor 102 with the chamber blades 114 advance in a counterclockwise rotational direction, represented by arcuated arrow 131 whereas the auxiliary rotor rotates in a clockwise rotational direction, represented by arcuated arrow 133. The chamber blade 114 and the engaging grooves are mutually configured by their shape and dimensions, such that during entry (FIG. 4A), being fully received (FIG. 4B) and exit (FIG. 4C) of a duty chamber blade 114 from an engaging groove 136, a side wall 139 of the chamber blade and one of the engaging groove's lips 137 or a peripheral face 115 of the chamber blade and an internal face 135 of the engaging groove are substantially sealingly engaged. This ensures substantial sealing engagement of the chamber blades at all times—both during their movement through the annular chamber and during its engagement with said engaging groove.

As can be seen in FIG. 2A. given the axial symmetry of the apparatus, each chamber blade 114 has an opposite chamber blade 116 that is in the same relative position vis-à-vis an auxiliary rotor 106; similarly each auxiliary rotor 106 has an opposite auxiliary rotor 106 that is in the same rotational phase. For example, in FIG. 1B this can be seen when comparing the auxiliary rotor marked as 116A and the opposite one marked 116B, as well as the corresponding chamber blades 114A and 114B.

Defined in the stator are twelve (12) first fluid flow paths and twelve (12) second fluid flow paths that are defined by respective through bores 140 and 142 and seen in cross-section in FIGS. 2A-3C and in isometric view in FIGS. 5A-5F. The first flow paths 140 and the second flow paths 142 extend from respective first ports 144 and second ports 146 (best seen in FIGS. 5C-5D) in the internal annular stator surface 110. Associated with each auxiliary rotor are a pair of flow paths consisting of one first flow path 140 and one second flow path 142 and their corresponding first and second ports 144,146. The first port 144 is disposed on one side of the auxiliary rotor 106 that faces the first direction of rotation, namely that side from which, in the compressor configuration of the apparatus, the rotating chamber blades approach the auxiliary rotor, and the second port 146 is disposed on the other side of the auxiliary rotor. As can be seen the first and the second ports 144,146 are defined by small bores that extend from the through bores 140,142 that define the first and second flow paths and open into the confined annular fluid space 112 at the periphery of the abutting portion 116.

The auxiliary rotors, as can best be seen in FIGS. 5A-5F, 7 and 9A, have each two radially extending annular flow control elements 148,150. The two flow-control elements are equally spaced from and at opposite sides of the abutting portion. By an embodiment of this disclosure, each of the flow control element comprises two arcuated openings axially symmetrical about the auxiliary axis. Each of these elements intersects through bores 140,142 and, thus, have an intersecting annular portion that rotates within these through bores. Each of the intersecting annular portions has two arcuated openings, 152 in flow control element 148 and two arcuated opening 154 in flow control element 150, of which only one is seen in the figures. The arcuated openings are axially symmetrically disposed about the auxiliary axis. In the compressor configuration only flow control elements 148 play a role and the through bores are blocked by a plug or sealing barrier (not shown) at a through bore section that lies in between the confines annular space 112 and flow control element 150. In other configurations, such as in the expander configuration, control element 150 is operational and the block in the first and second through bores 140,142 will be placed in the opposite side, namely between the annular space 112 and flow control element 148.

The description will now focus on the compressor configuration, with occasional references also to the expander configuration of the apparatus 100. In this embodiment the annular portion that intersects the first through bores 140 also intersect the second through bores 142, whereby the annular openings serve, in different rotational phases to open both through bores, thus permitting fluid flow through the respective first and second flow paths.

The blocking and opening of through bore 140 is also clearly seen in FIGS. 5A-5F, wherein FIGS. 5A, 5C and 5E show a state in which an annular portion without an opening is in register with the through bore 140, while FIGS. 5B, 5D and 5F show a state in which the openings 152 are in register with the through bore 140 permitting fluid flow through the first flow path.

The throughgoing bores that, as can be seen, extend each along a bore axis that is substantially parallel to the auxiliary and main axes, define a first section, and as can be seen in FIGS. 5C and 5D, there is a second section with a plurality of fine ducts 147 that extend from the first section to the annular confined chamber 112 along parallel duct axes that are normal to said bore axis. The plurality of such ducts serves as a manifold to ensure a substantially even inflow or outflow of fluid into or out of the confined annular space. The ports (including the first and/or the second ports) that are defined by the one or more ducts are formed at an internal annular stator surface adjacent the abutting portion 116. The throughgoing bore, that defines the first flow path extends between a proximal opening at one side of the stator and the opposite side, with the first section being defined between the proximal opening and a sealing barrier (not shown) within the bore.

FIGS. 3A-3C show an enlarged cross-sectional view with the annular openings super-imposed: the relatively broad lines represent the relatively wider annular openings 152 of the flow control element 148 and the relatively narrow lines represent annular openings 154 of the flow control element 145 (these openings can be seen in FIGS. 5A-5B). When discussing the compressor configuration, annular openings 154 can be ignored, as the flow path to the section that these intersects is blocked, as noted above.

In a rotational phase in which one the openings is in register with the flow path, the flow path is open. This can be seen, for example, in FIG. 3B, where openings 144 are in register with through bores 142, thus permitting fluid flow through the second flow path into chamber 170 defined between the right abutting portion 116 and the blade 114D that recedes therefrom. As also seen in FIG. 3B, the through bore 140 adjacent the left abutting portion 116 is blocked and consequently, the chamber blade 114D that rotates towards the right abutting portion 116 compresses the fluid in compartment 172.

The stator 105 is assembled from a plurality of sectorial stator segments 158 that can be seen in FIGS. 5A-5B, 5E-5F, 7 and 9A, each defining a segment of the internal annular stator surface 110. The number of stator segments is equal to the number of auxiliary rotors, being twelve in this embodiment. All the sectorial stator segments 158 are identical and are axially symmetrically disposed about the central axis. Each stator segment 158 defines half of a receiving space 160 for an auxiliary rotor, the other half being defined in a stator segment 158, whereby two adjacent sectorial stator segments 158 define between them a dedicated space that accommodates an auxiliary rotor in a tight fitness. The stator segments 158 are held together by tensioning rings 107A,107B, as already noted above.

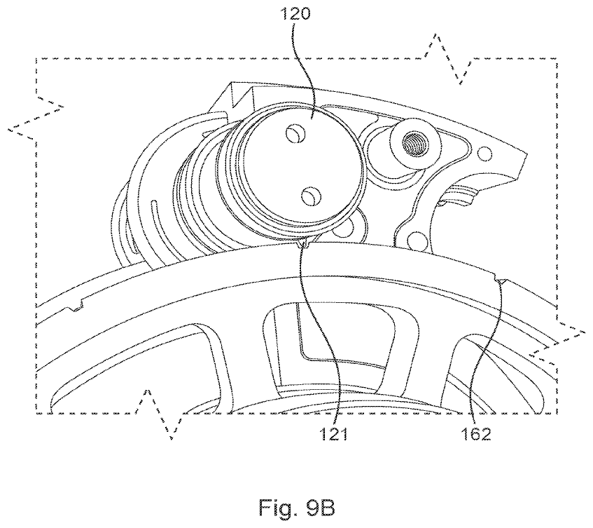

As can be seen in FIG. 8, the rotor 102 is part of a rotating block that comprises a main gear wheel 130 and a gate gear 161. The main gear is geared to the cogged face 128 of end portion 126 of the auxiliary rotor 106, to thereby rotate the auxiliary rotors. The gate gear 161 has gating component in the form of gating grooves 162, each in radial alignment with one of the chamber blades 114. The gating grooves are dimensioned for coupling with counterpart gating components on a gating portion of the auxiliary rotors 106, being gating blades 121 formed on cylindrical end portion 120. One of the functions of the gating components is to ensure proper alignment of the auxiliary rotors during assembly of the apparatus. During assembly, the auxiliary rotors are positioned such that said gating component is aligned with said counterpart component, in this case blade 121 and gating groove 162, as can be seen in FIG. 9B. This ensures proper alignment of the auxiliary rotors. Typically, the gating blades 121 and the gating grooves 163 are dimensioned such that there is always a small space between them and both do not touch during rotation.

The apparatus 100 will now be described with respect to its compressor configuration, with particular reference to FIGS. 3A-3C.

In the compression operational mode or configuration of apparatus 100, the annular confined space 112 serves for compression of a WF. The main rotor is rotatable in a first, counterclockwise, compression direction, represented by arrows 134, while the auxiliary rotor rotates in an opposite, clockwise rotational direction, as represented by arrows 135.

The arcuated openings 152 of flow control elements 148 configure a valving arrangement for selectively synchronized opening and closing of the first and the second flow paths. In the following description, intersecting portions of the flow control element, other than the annular openings, will be referred to as “flow-blocking portion”.

In explaining the compression operation, focus will be made on the compartment of the annular confined space 112 that is defined between the two consecutive abutting portions 116. In FIG. 3A, the right chamber blade, referred in FIGS. 3A-3C, as chamber blade 114D, is disengaging from an engagement groove 136 of the right abutting portion 116. At this phase a flow-blocking portion is in register with throughgoing bore 142 adjacent the blade 114D and flow therethrough and, hence, through the respective second flow path is blocked, while an arcuated opening 152 of the left auxiliary rotor is in register with the respective bore 140 and this bore and the associated first flow path is hence open. As the blade 114D advances past port 144, as seen in FIG. 3B, the arcuated opening 152 of the right auxiliary rotor registers with throughgoing bore 142 and flow-blocking portion of the left auxiliary rotor rotates into register with throughgoing bore 140 and, hence the flow of fluid through the corresponding first flow path is blocked.

Chamber blade 114D defines two separate compartments 170 and 172. The first of these compartments 170, defined between the right abutting portion and the blade 114D that recedes therefrom, is a temporary intake compartment into which fluid is drawn from an external reservoir in fluid connection with throughgoing bore 142, enabled by the respective opening 152. Against this, compartment 172 is a compression compartment temporarily defined between the abutting portion on the left, towards which the blade 114D advances, enabled through flow blockage by the flow-blocking portion that arrest flow fluid therethrough. At an end phase, seen in FIG. 3C, blade 114D proximates the right abutting portion and then another annular opening 152 comes into register with bore 140 discharging the compressed fluid from the compression compartment 172. through a first port when the blade of said chamber is proximal to the auxiliary rotor.

The apparatus 100 can also be operated in an expander configuration. To this end, as already noted above, the throughgoing bores 140 and 142 are fitted with a flow-blocking plug or seal that enables flow through the bores sections that are intersected by flow control elements 150, rather than through bores sections that are intersected by flow control elements 148, which are employed in the compression configuration. In the expander configuration the main rotor rotates in an opposite, second direction of rotation. The reader should consider the sequence shown in FIGS. 3A-3C in reverse while focusing on the thin arcuated openings 154 that represent as the thin lines in these figures.

The apparatus can also be configured for dual operation, both and an expander and as a compressor. In this case, for example, a flow control element may be introduced into the throughgoing bores, providing for flow through the expander relevant sections in the expander operational mode or through the compression relevant sections in the expander operational mode.

1-31. (canceled)

32. An apparatus comprising: a main rotor rotatable about a central axis and having a peripheral rotor surface; a stator having internal annular stator surface segments spaced apart from said peripheral rotor surface to define an annular confined space therebetween; a plurality of auxiliary rotors disposed in said stator, each geared to the main rotor and rotatable therewith in a direction of rotation opposite to that of the main rotor about an auxiliary axis parallel to the central axis and having a central, generally cylindrical, abutting portion with an engaging surface that abuts into the annular confined space between consecutive segments of the internal annular stator surface and is configured to roll at sealing fitness over the external peripheral surface of the rotor; a plurality of chamber blades disposed on said peripheral surface and extend therefrom into said annular chamber, each of which substantially sealingly engage said internal surface; one or more engaging grooves defined in the engaging surface, each of the grooves being configured to sealingly receive one of the chamber blades during rotations of the auxiliary rotors and said rotor, the gearing of the auxiliary rotors to the rotor being such that a duty blade of the plurality of chamber blades is received within a duty groove of the one or more engaging grooves; characterized in: a plurality of first and second fluid flow paths extending from respective first and second ports in the internal annular stator surface, each pair of a first flow path and second flow paths and their respective first and second ports are associated with one auxiliary rotor, with the first port being disposed on one side of the auxiliary rotor that faces the first rotational direction and the second port on the other side of the auxiliary rotor; the auxiliary rotors comprise each one or more radially extending annular flow control element having an annular portion intersecting both the first and the second flow paths, the intersecting annular portion having one or more arcuated openings, whereby in a rotational phase in which one the openings is in register with the flow path, the flow path is open, and is closed in other rotational phases.

33. The apparatus of claim 32, wherein each auxiliary rotor comprises two flow control elements, each one operable in a different operational mode of the apparatus.

34. The apparatus of claim 33, wherein for each auxiliary rotor, the two flow-control elements are equally spaced from and at opposite sides of the abutting portion.

35. The apparatus of claim 34, wherein each of the flow control element comprises two arcuated openings axially symmetrical about the auxiliary axis.

36. The apparatus of claim 35, wherein the chamber blades are axially symmetrically disposed about said main rotor, and the auxiliary rotors are axially symmetrically disposed in said stator.

37. The apparatus of claim 36, comprising: a rotating block that comprises said rotor, a main gear wheel and a gate gear; the main gear being geared to a cogged portion of the auxiliary rotor; and the gate gear having gating components dimensioned for coupling with counterpart components on a gating portion of the auxiliary rotors.

38. The apparatus of claim 37, wherein said peripheral gating components are gating blades and said counterpart gating components are matching gating grooves.

39. The apparatus of claim 38, wherein the peripheral gating components are in angular alignment with the chamber blades.

40. The apparatus of claim 39, wherein the stator comprises a plurality of identical sectorial stator segments axially disposed about the central axis, the segments defining together said stator surface, and each auxiliary rotor being received between a pair of neighboring sectorial segments.

41. The apparatus of claim 40, wherein each of said engaging grooves has a generally rectangular cross-sectional shape with rounded external lips; and each of said chamber blades has a generally concave hourglass cross-sectional shape configured such that during its entry to and exit from an engaging groove a side wall of the chamber blade and one of the engaging groove's lips or a peripheral face of the chamber blade and an internal face of the engaging groove are substantially sealingly engaged.

42. The apparatus of claim 41, comprising a first number of chamber blades and a second number, smaller than the first number, of auxiliary rotors.

43. The apparatus of claim 42, comprising 7n of said blades and 6n of said auxiliary rotors, n being an integer.

44. The apparatus of claim 43 wherein each of the first and second paths comprise: a first section that is formed by a throughgoing bore extending a along a bore axis substantially parallel with the auxiliary axis; and a second section comprising one or more ducts extending from the first section to the annular chamber.

45. The apparatus of claim 44, wherein, the apparatus is operable in a compressor operational mode; the main rotor is rotatable in a first, compression direction of rotation about the central axis; the one or more arcuated openings define a valving arrangement for selectively synchronized opening and closing the first and second flow paths yielding (i) intake of fluid through a second port into an intake compartment temporarily defined between an abutting portion of an auxiliary rotor and a blade that rotates away from the abutting portion, (ii) compression of fluid in a compression compartment temporarily defined between an abutting portion of an auxiliary rotor and a blade that rotates towards the abutting portion, and (iii) discharge of compressed fluid from said compression compartment out through a first port when the blade of said compartment is proximal to the abutting portion.

46. The apparatus of claim 45, wherein the valving arrangement is operational to open the first flow path, when an approaching duty blade is in proximity to the auxiliary rotor and close the first flow path after the duty blade disengages a duty groove; and open the second flow path when a duty blade disengages a duty groove and close the second flow path when the next duty blade is fully received in a duty groove.

47. The apparatus of claim 44, wherein the apparatus is operable in expander operational mode; the main rotor is rotatable in a second, expansion direction of rotation about the central axis; and wherein the one or more arcuated openings define a valving arrangement for selectively synchronized opening and closing the first and second flow paths such that (i) there is intake of pressurized fluid through a first port into a pressurized fluid compartment temporarily defined between an abutting portion of an auxiliary rotor and a blade that rotates away from the abutting portion, (ii) expansion of fluid in an expansion compartment temporarily defined between an abutting portion of an auxiliary rotor and a blade that rotates away from the abutting portion, and (iii) discharge of the expanded fluid from said expansion compartment out through a second port when the blade of said compartment is proximal to the abutting portion.

48. The apparatus of claim 44, wherein the apparatus is operable in a fluid compression and in a fluid expansion operational mode; the main rotor is rotatable in a first compression direction and in an opposite, second expansion direction of rotation about the central axis; and wherein the main rotor is rotatable in a first compression direction and in an opposite second, expansion direction of rotation about a central axis and having a peripheral rotor surface; and wherein the one or more arcuated openings define a valving arrangement for selectively synchronized opening and closing the first and second flow to yield in said compression rotation there being (i) intake of fluid through a second port into an intake compartment temporarily defined between an auxiliary rotor and a blade that rotates away from the auxiliary rotor, (ii) compression of fluid in a compression compartment temporarily defined between an auxiliary rotor and a blade that rotates towards the auxiliary rotors, and (iii) discharge of compressed fluid from said compression compartment out through a first port when the blade of said compartment is proximal to the auxiliary rotor, and in said expansion rotation there being (i) intake of pressurized fluid through a first port into a pressurized fluid compartment temporarily defined between an abutting portion of auxiliary rotor and a blade that rotates away from the abutting portion, (ii) expansion of fluid in an expansion compartment temporarily defined between an abutting portion of an auxiliary rotor and a blade that rotates away from the abutting portion, and (iii) discharge of the expanded fluid from said expansion compartment out through a second port when the blade of said compartment is proximal to the abutting portion.

49. A compressor system comprising the apparatus of claim 45 operable in a compression operational mode, and a motor rotationally coupled to the main rotor for rotating the rotor in said first rotational direction.

50. An expander system comprising the apparatus of claim 47 operable in an expansion operational mode, and an energy generator rotationally coupled to the main rotor for rotating the rotor in said second rotational direction.

51. A system for use in compressing a fluid and in utilizing a compressed fluid for generation of energy, comprising: the apparatus of claim 48; a motor rotationally couplable to the main rotor in a compression operational mode, for rotating the rotor in said first rotational direction; and an energy generator rotationally couplable to the main rotor in an expansion operational mode for rotating the rotor in said second rotational direction.
